(19) United States
(12) Patent Application Publication
(10) Pub. No.: US 2014/0297956 A1
(43) Pub. Date: Oct. 2, 2014

(54) ARITHMETIC PROCESSING APPARATUS, INFORMATION PROCESSING APPARATUS AND CONTROL METHOD OF ARITHMETIC PROCESSING APPARATUS

(71) Applicant: FUJITSU LIMITED, Kawasaki-shi (JP)

(72) Inventors: Takashi Ishinaka, Ota (JP); Jun Moroo, Isehara (JP)

(73) Assignee: FUJITSU LIMITED, Kawasaki-shi (JP)

(21) Appl. No.: 14/207,850

(22) Filed: Mar. 13, 2014

(30) Foreign Application Priority Data
Mar. 27, 2013 (JP) 2013-067651

(51) Int. Cl. G06F 12/08

(52) U.S. Cl. CPC G06F 12/084; G06F 12/0806
USPC 711/119; 711/130

(57) ABSTRACT

An arithmetic processing apparatus includes a plurality of first processing units to be connected to a cache memory; a plurality of second processing units to be connected to the cache memory and to acquire, into the cache memory, data to be processed by the first processing unit before each of the plurality of first processing units executes processing; and a schedule processing unit to control a schedule for acquiring the data of the plurality of second processing units into the cache memory.

### CROSS-REFERENCE TO RELATED APPLICATIONS

This application is based upon and claims the benefit of priority of the prior Japanese Patent Application No. JP2013-067651, filed on Mar. 27, 2013, the entire contents of which are incorporated herein by reference.

### FIELD

The present invention relates to an arithmetic processing apparatus including a cache memory and a plurality of processing units.

### BACKGROUND

Such information processing is dominant in processing of a computer as the case may be that a processing unit, e.g., a processor, for program's processing, accesses a memory, reads out data, processes the readout data and writes the data back to the memory. The processing unit will hereinafter be referred to also as a core.

Such being the case, a high-speed and small-capacity memory called a cache is disposed between the processing unit and a memory existing outside the processing unit in order to improve a memory accessing speed. Namely, there is utilized a method of increasing a substantial speed at which the processing unit accesses the memory through the cache.

This cache technology involves widely utilizing “prefetch” of predicting a memory that will be accessed by the processing unit, reading data beforehand from the external memory and writing the readout data to the cache. The prefetch is realized by, e.g., embedding a prefetch instruction for instructing execution of prefetching into a binary program when compiled.

While on the other hand, a method of shortening a clock cycle of the processing unit and attaining a higher frequency has a limit to an improvement of a calculation speed. Therefore, such a method is taken at the present that a multiplicity of processing units conducting the calculations is operated in parallel. Further, a system is proposed, which previously acquires the data with a instruction such as the prefetch instruction by use of an auxiliary processing unit before, e.g., the processing unit performing the calculation.

### DOCUMENTS OF PRIOR ARTS

### Patent Documents

[Patent document 1] Japanese Unexamined Patent Publication No. 2004-517383
[Patent document 2] Japanese Patent Application Laid-Open Publication No. 2010-55458
[Patent document 3] Japanese Patent Application Laid-Open Publication No. 2001-175619
[Patent document 4] Japanese Patent Application Laid-Open Publication No. 2008-59057
[Patent document 5] Japanese Patent Application Laid-Open Publication No. 2011-141743

### SUMMARY

According to an aspect of the embodiments, an arithmetic processing apparatus including a plurality of first processing units to be connected to a cache memory; a plurality of second processing units to be connected to the cache memory and to acquire, into the cache memory, data to be processed by the first processing unit before each of the plurality of first processing units executes processing; and a schedule processing unit to control a schedule for acquiring the data of the plurality of second processing units into the cache memory.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating a configuration of an arithmetic processing apparatus according to a comparative example;

FIG. 2 is a diagram illustrating sequences of instructions executed by a plurality of calculation cores;

FIG. 3 is a diagram illustrating a relationship of execution timing of each of instructions in the sequences of instructions executed by the plurality of calculation cores;

FIG. 4 is a diagram illustrating a configuration of the arithmetic processing apparatus according to a first working example.

FIG. 5 is a flowchart of a process executed by a cache scheduler according to the first working example;

FIG. 6 is a diagram illustrating a process of an assistant core to receive a request for executing a prefetch instruction;

FIG. 7 is a diagram illustrating an effect of the arithmetic processing apparatus in the first working example;

FIG. 8 is a diagram illustrating a configuration of the arithmetic processing apparatus according to a second working example.

FIG. 9 is a flowchart illustrating processes executed by a cache scheduler according to the second working example.

### DESCRIPTION OF EMBODIMENT(S)

An arithmetic processing apparatus according to one embodiment will hereinafter be described with reference to the drawings. A configuration of the following embodiment is an exemplification, and the present arithmetic processing apparatus is not limited to the configuration of the embodiment.

By the way, in the case of an arithmetic processing apparatus including a plurality of processing units performing the calculations, timing of acquiring the data beforehand is different on a per processing unit basis. Accordingly, if the technology using an auxiliary processing unit for acquiring the data beforehand is expanded to the arithmetic processing apparatus including the plurality of processing units, such a situation can occur that the data cannot be yet prepared when one of the plurality of processing units performing the calculation needs the data.

### Comparative Example

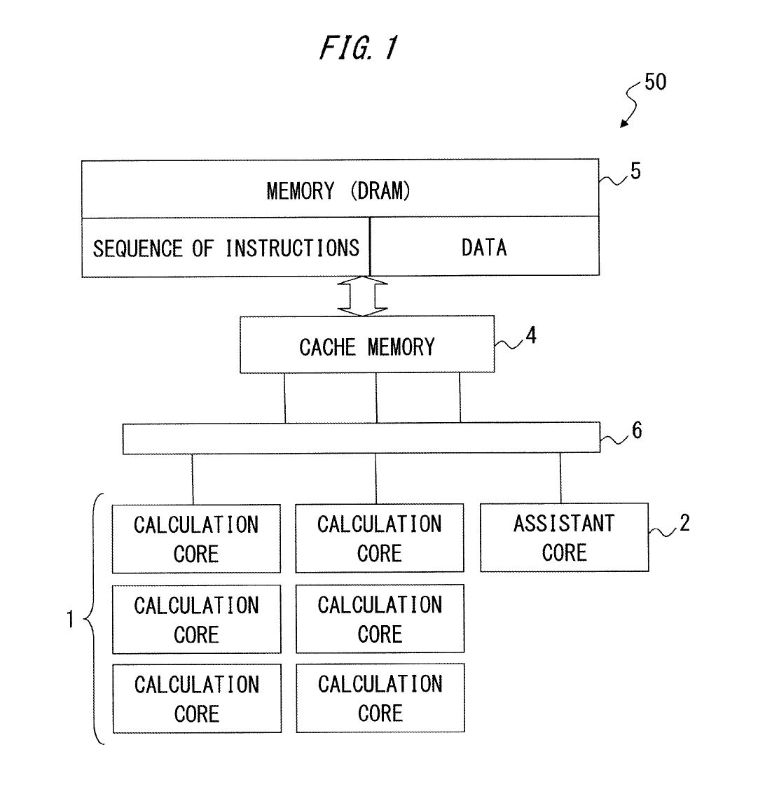

The arithmetic processing apparatus according to a comparative example will be described with reference to FIGS. 1 through 3. FIG. 1 is a diagram illustrating a configuration of an arithmetic processing apparatus 50 according to the comparative example. The arithmetic processing apparatus 50 includes a plurality of calculation cores 1, an assistant core 2, a cache memory 4, a memory 5 and a crossbar 6. FIG. 1 depicts the plurality of calculation cores 1. The individual calculation cores, in the case of their being distinguished from each other, will hereinafter be called such as the calculation cores 1-1, 1-2. Further, an aggregation of the plurality of calculation cores 1 is also called a processor.

The calculation cores 1 acquire sequences of instructions of the computer program deployed in an executable manner on the memory 5 and data via the cache memory 4. Then, the calculation cores 1 process the acquired data by executing the acquired sequences of instructions, and store processed results in the memory 5 via the cache memory 4.

The sequences of instructions executed by the calculation cores 1 contain the prefetch instruction embedded by a compiler when compiling a source program. Each of the calculation cores 1, when acquiring the prefetch instruction, requests the assistant core 2 to execute the prefetch instruction.

The assistant core 2 executes the prefetch instruction in accordance with the request issued from the calculation core 1. The data are acquired into the cache memory 4 by executing the prefetch instruction. Accordingly, it follows that when the calculation core 1 processes the data, processing target data are to exist in the cache memory 4. Namely, the assistant core 2 serving as a core for executing the prefetch assists the calculation core 1 in efficiently executing the process.

The cache memory 4 is a memory, though small of capacity, from and to which the data can be read and written at a high speed. The memory 5 has a larger capacity than the cache memory 4 has but has a slower speed in reading and writing the data than the cache memory 4 has. The calculation cores 1 efficiently make use of the cache memory 4, thereby speeding up the processes of the arithmetic processing apparatus 50.

In the architecture of FIG. 1, the plurality of calculation cores 1 and the assistant core 2 are accessible in parallel with each other to the cache memory 4. For example, the plurality of calculation cores 1 and the assistant core 2 access the cache memory 4 in parallel via the crossbar 6. The crossbar 6 is also called an interconnection network. The crossbar 6 establish parallel connections between the cache memory 4 and a plurality of cores (core group) including the plurality of calculation cores 1 and the assistant core 2 at the same cycle. In one example of the configuration, the cache memory 4 can be segmented into, e.g., eight memory banks. In this case, the crossbar 6 establishes the parallel connections between the eight cores and the eight memory banks.

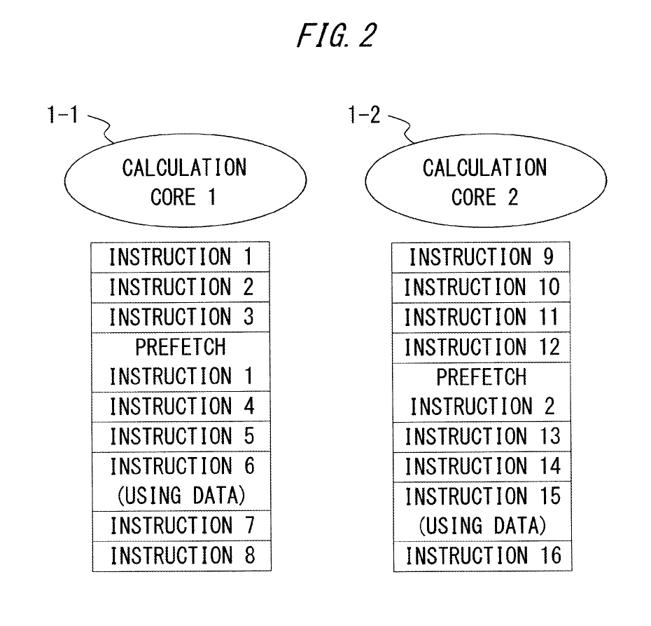

FIG. 2 illustrates sequences of instructions executed by the plurality of calculation cores 1-1, 1-2, etc. For example, the calculation core 1-1 executes instructions 1-3, a prefetch instruction and instructions 4-8. Further, an assumption in the working example is that the instruction 6 is to use, it is known at a compiling stage, the data acquired by the prefetch instruction 1. Similarly, the calculation core 1-2 executes instructions 9-12, a prefetch instruction 2 and instructions 13-16. Moreover, the assumption is that the instruction 15 is to use, it is known at the compiling stage, the data acquired by the prefetch instruction 2.

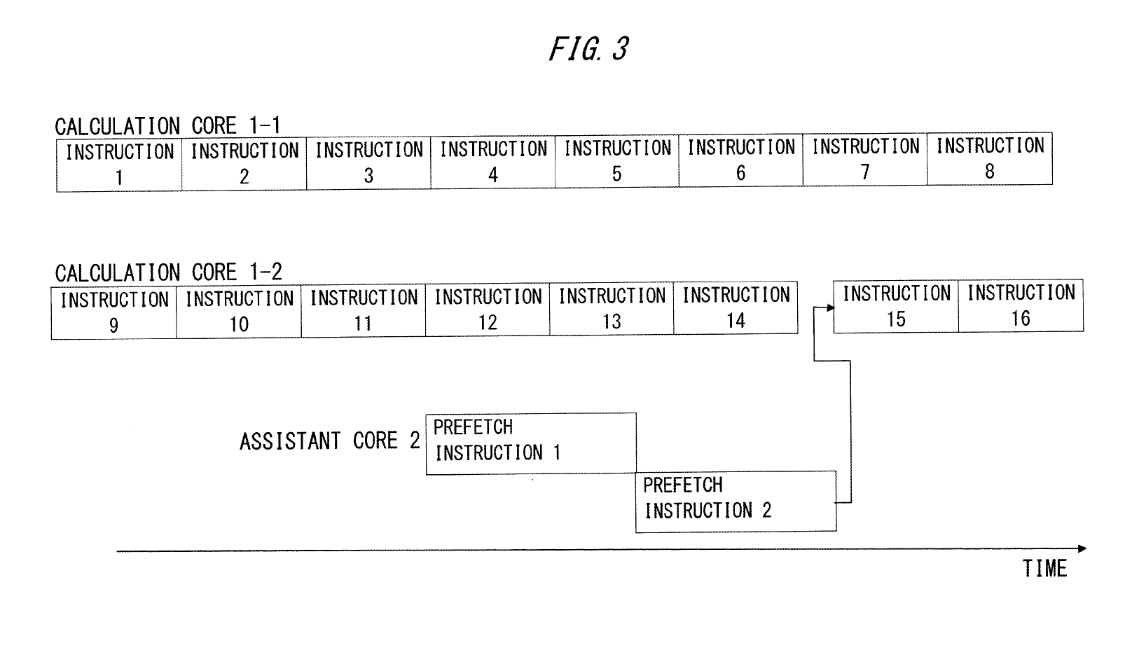

FIG. 3 is a diagram illustrating a relationship of execution timing of each of instructions in the sequences of instructions executed by the plurality of calculation cores 1-1, 1-2. As in FIG. 3, the prefetch instruction is executed by the assistant core 2. For instance, during processing of a pipeline, the calculation core 1-1, when acquiring the prefetch instruction 1, transfers the prefetch instruction 1 to the assistant core 2 and requests the assistant core 2 to execute this prefetch instruction 1, and further executes the instruction 4 at one stage. Accordingly, in the configuration of the comparative example, any delay does not occur in the pipeline of the calculation core 1-1 due to existence of the prefetch instruction.

On the other hand, the assistant core 2, when receiving a request for executing the prefetch, during a period for which, e.g., the calculation core 1-1 executes the instructions 4 and 5, executes prefetching corresponding to the prefetch instruction 1.

By the way, the calculation core 1-2 acquires the prefetch instruction 2 next to the instruction 12. In the example of FIG. 3, however, when the calculation core 1-2 acquires the prefetch instruction 2, the assistant core 2 executes prefetching underway as the prefetch instruction 1 instructs. Accordingly, the assistant core 2 cannot, even when receiving the request for executing the prefetch instruction 2 from the calculation core 1-2, immediately execute the prefetch instruction 2. Hence, delays occur when the assistant core 2 starts executing the prefetch instruction 2 and when completing the execution thereof. Therefore, in the calculation core 1-2, the execution start timing of the instruction 15 for processing the data acquired by the prefetch instruction 2 is delayed till completing the execution of the prefetch instruction 2. Namely, the plurality of calculation cores 1 executes the instructions in parallel, in which case such an instance can occur that some prefetch instructions cannot beforehand prepare the data with respect to some number of cores.

### First Working Example

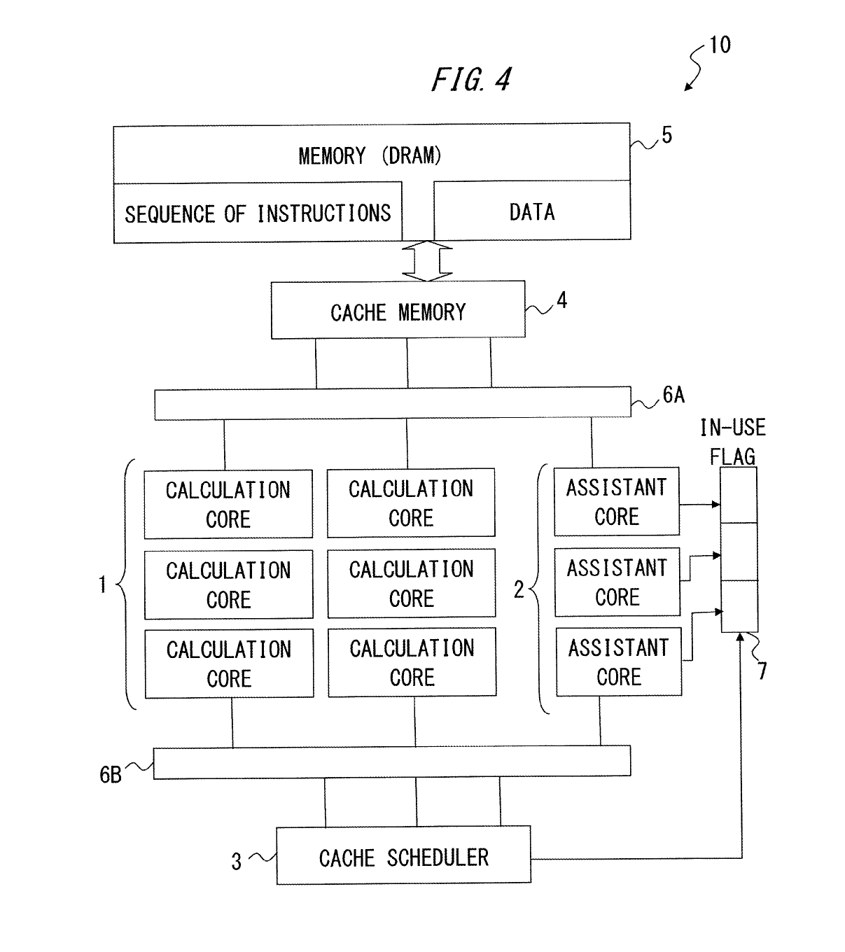

An arithmetic processing apparatus 10 according to a working example will hereinafter be described with reference to FIGS. 4 through 8. FIG. 4 is a diagram illustrating a configuration of the arithmetic processing apparatus 10 according to a first working example. The arithmetic processing apparatus 10 includes a plurality of calculation cores 1, a plurality of assistant cores 2, a cache scheduler 3, a cache memory 4, a memory 5 and crossbars 6A, 6B. The arithmetic processing apparatus 10 includes, as compared with the arithmetic processing apparatus 50 in the comparative example illustrated in FIG. 1, the plurality of assistant cores 2 and further the cache scheduler 3. The configuration of the arithmetic processing apparatus 10 other than the plurality of assistant cores 2 and the cache scheduler 3 is substantially the same as the configuration of the arithmetic processing apparatus 50 in the comparative example. The calculation core 1 is one example of a first processing unit. The assistant core 2 is one example of a second processing unit. The cache scheduler 3 is one example of a schedule processing unit. The memory 5 is one example of main memory.

A configuration and an operation of the assistant core 2 are the same as those in the arithmetic processing apparatus 50 in the comparative example. The arithmetic processing apparatus 10 in the working example has, however, a difference from the arithmetic processing apparatus 50 in the comparative example in such a point that the plurality of assistant cores 2 accesses the cache memory 4 in parallel via the crossbar 6A.

To be specific, the plurality of calculation cores 1 and the plurality of assistant cores 2 access the cache memory 4 in parallel via the crossbar 6A. For instance, similarly to the case of FIG. 1, the cache memory 4 is segmented into eight memory banks. The crossbar 6A connect the eight cores included in the plurality of calculation cores 1 and the plurality of assistant cores 2 to the eight memory banks of the cache memory 4 in parallel. In the first working example, however, it does not mean that the number of the memory banks of the cache memory 4 is limited to “8”.

Moreover, in the first working example, each of the assistant cores 2 includes a register 7 that is readable from the cache scheduler 3. Each of the assistant cores 2 individually sets, in the register 7, a busy flag which may be called as in-use flag indicating whether each assistant core 2 is used underway or not. A status of “the assistant core 2 is used underway” can be exemplified by a status in which the assistant core 2 executes prefetching underway.

The cache scheduler 3 includes cores for executing the instructions deployed in the executable manner on, e.g., a main storage device and also the main storage device stored with the sequences of instructions executed by the cores and the data processed by the cores. The cache scheduler 3 executes the sequences of instructions on the main storage device, thereby communicating with the plurality of calculation cores 1 and the plurality of assistant cores 2 via the crossbar 6B. Note that the crossbar 6B and crossbar 6A may be configured as the same crossbar. Namely, such a configuration may be taken that the plurality of calculation cores 1, the assistant cores 2, the cache scheduler 3 and the cache memory 4 are connected by the crossbar 6A. However, the crossbar 6A may be configured to connect the respective memory banks of the cache memory 4 to the cores (core group) including the plurality of calculation cores 1 and the plurality of assistant cores 2 independently of the crossbar 6B. In this case, the crossbar 6B may be configured to connect the cache scheduler 3 to the cores (core group) including the plurality of calculation cores 1 and the plurality of assistant cores 2 independently of the crossbar 6A and the cache memory 4.

In any configurations, the cache scheduler 3 receives notification of the prefetch instruction from the calculation core 1 via the crossbar 6B. The prefetch instruction contains an address of the memory 5 becoming a prefetch target.

The cache scheduler 3, when receiving the prefetch instruction from any one of the calculation cores 1, determines the assistant core 2, which is in a null status and remains enabled to execute the prefetch instruction, in the plurality of assistant cores 2. For example, the cache scheduler 3 accesses the register 7 and, if there exists the plurality of assistant cores 2 kept in the null status, selects any one of these assistant cores 2. It does not, however, mean that there is a limit to a way of the selection. For instance, it may be sufficient that the cache scheduler 3 selects the assistant core 2 with its null status being recognized first through the register 7. Note that in the configuration of FIG. 10, the cache scheduler 3 accesses the register 7 via a dedicated transmission path. The cache scheduler 3 may also, however, be configured to access the register 7 via a crossbar 7B.

Then, the cache scheduler 3 requests the selected assistant core 2 kept in the null status to execute the prefetch instruction of which the calculation core 1 notifies. The assistant core 2 receiving the request for executing the prefetch instruction executes prefetching from the address of the memory 5 specified by the prefetch instruction. Accordingly, when the calculation core 1 accesses the memory 5, it follows that the data of the accessed address will have been already prepared in the cache memory 4.

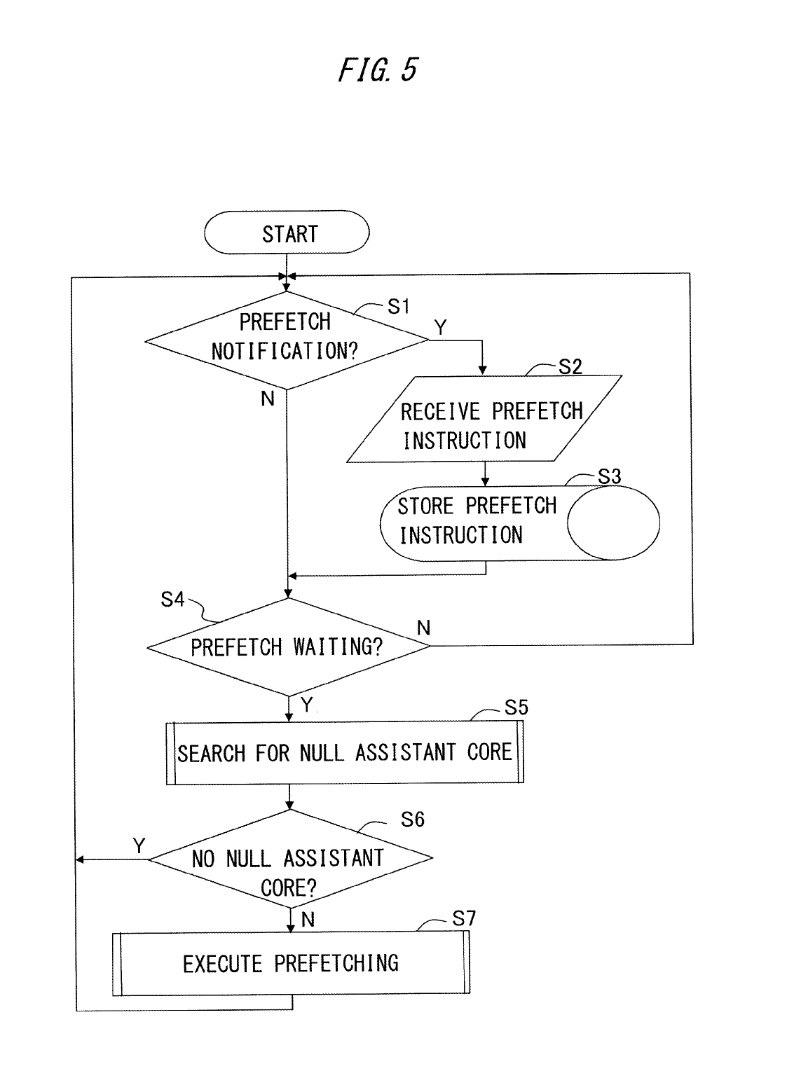

FIG. 5 illustrates a flowchart of a process executed by the cache scheduler 3. In this process, at first, the cache scheduler 3 determines whether or not the notification of a prefetch instruction is received from any one of the calculation cores 1 via the transmission path (S1). If there is the received notification of the prefetch instruction, the cache scheduler 3 receives the notified prefetch instruction (S2). Then, the cache scheduler 3 stores the prefetch instruction in a queue of the main storage device (S3).

Subsequently, the cache scheduler 3 determines whether the prefetch instruction is left in a waiting status in the queue or not (S4). If it is determined S4 that there is the prefetch instruction in the waiting status, the cache scheduler 3 searches for the null assistant core 2 (S5). As described above, the cache scheduler 3 refers to the register 7 of each of the plurality of assistant cores 2, and it may be sufficient that the assistant core 2 determines whether in the null status or not.

Then, as a result of the process in S5, if the null assistant core 2 does not exist (No in S6), the cache scheduler 3 loops the control back to S1. Namely, the cache scheduler 3 repeats the process from determining whether there is the notification of the prefetch instruction or not. Whereas if it is determined in S6 that the null assistant core 2 exists (YES in S6), the cache scheduler 3 accesses the null assistant core 2 searched for in S5 via the crossbar 6B and requests this assistant core 2 to execute the prefetch instruction (S7). The scheduler 3 requests the assistant core 2 for the execution of the prefetch instruction by use of a predetermined instruction given thereto. Thereafter, the cache scheduler 3 loops the control back to S1.

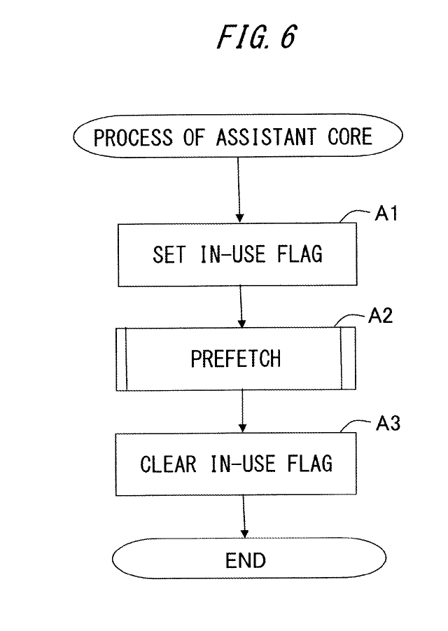

FIG. 6 illustrates a process of the assistant core 2 receiving the request for executing the prefetch instruction. A start of the process in FIG. 6 is triggered by receiving the request for the execution of the prefetch instruction from the cache scheduler 3 via the crossbar 6B. Upon receiving the request for the execution of the prefetch instruction, the assistant core 2 sets the busy flag indicating an in-use status in the register 7 (A1). Then, the assistant core 2 executes the prefetch instruction from the address of the memory 5 specified due to the request for the execution of the prefetch instruction (A2). Subsequently, when completing the prefetch instruction, the assistant core 2 clears the busy flag indicating the in-use status, which is set in the register 7 (A3).

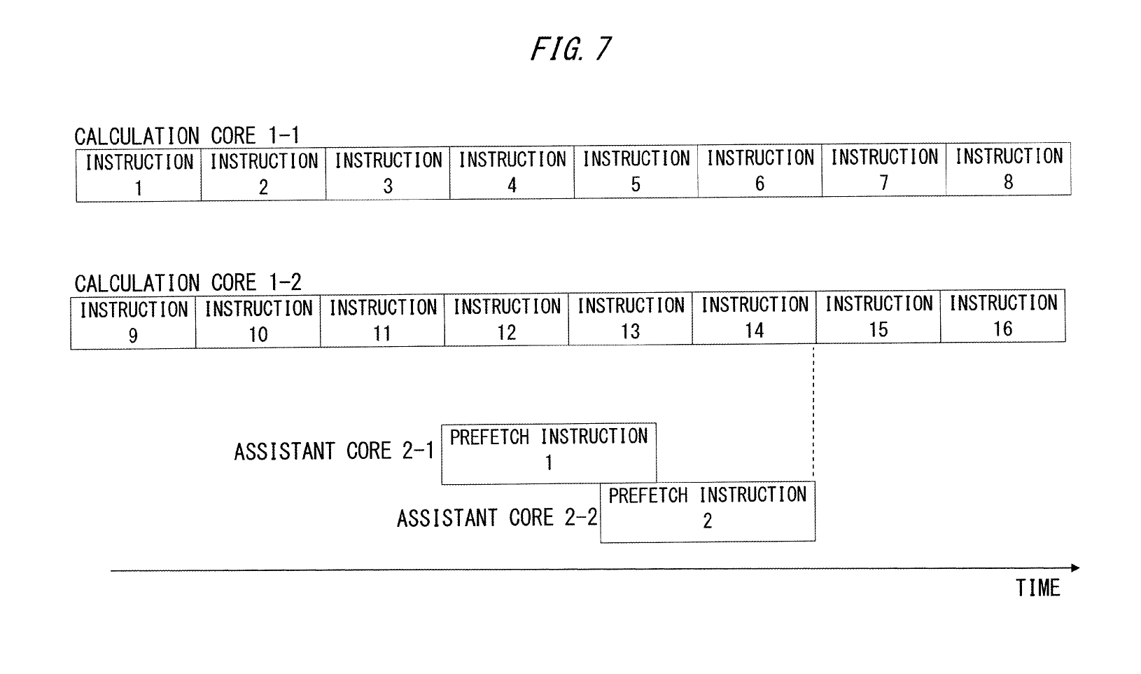

FIG. 7 illustrates an effect of the arithmetic processing apparatus 10 in the first working example. Herein, such a case is assumed that the same instruction as in the comparative example of FIG. 2 is executed. To be specific, similarly to FIG. 2, the calculation core 1-1 recognizes the prefetch instruction next to the instruction 3. For instance, the calculation core 1-1, if the prefetch instruction exists in the decoded sequence of instructions after the instruction fetch next to the instruction 3, notifies the cache scheduler 3 of the prefetch instruction. The cache scheduler 3, when receiving the notification of the prefetch instruction from the calculation core 1-1, searches for any one of the plurality of assistant cores 2 in the null status and requests this one of assistant cores 2 in the null status to execute the prefetch instruction in accordance with a processing flow in FIG. 5. In this case, the data prefetched by the prefetch instruction is assumed to be used by the instruction 6.

Similarly, the calculation core 1-2 recognizes the prefetch instruction next to the instruction 12. For example, the calculation core 1-2, if the prefetch instruction exists in the decoded sequence of instructions at the instruction fetch next to the instruction 12, notifies the cache scheduler 3 of the prefetch instruction. The cache scheduler 3, when receiving the notification of the prefetch instruction from the calculation core 1-2, searches for any one of the plurality of assistant cores 2 in the null status and requests this assistant core 2 to execute the prefetch instruction. In this case, the data prefetched by the prefetch instruction is assumed to be used by the instruction 15.

Unlike the case of the comparative example, in the first working example, the plurality of assistant cores 2 in the null status, which is searched for by the cache scheduler 3, can access the memory banks of the cache memory 4 in parallel via the crossbar 6A. Accordingly, as illustrated in FIG. 7, in the calculation core 1-1, the assistant core 2-1 executes the prefetch instruction recognized next to the instruction 3, and, in the calculation core 1-2, the assistant core 2-2 executes the prefetch instruction recognized next to the instruction 12.

The assistant core 2-1 and the assistant core 2-2 executes prefetching in parallel via the crossbar 6A and the plurality of memory banks of the cache memory 4. Therefore, unlike the example of the arithmetic processing apparatus 50 in the comparative example, the arithmetic processing apparatus 10 in the first working example enables the parallel operations of the plurality of assistant cores 2 on the basis of scheduling by the cache scheduler 3 in the case where the plurality of prefetch instructions are requested to be executed in the plurality calculation cores 1.

Namely, the cache scheduler 3, when receiving the prefetch request from the calculation core 1, searches for the assistant core 2 in the null status and requests the assistant core 2 in the null status to execute prefetching. As a result, in the first working example, also when the plurality of calculation cores 1 request for prefetching in parallel, the assistant cores 2 in the null status can prefetch in parallel. Accordingly, in the first working example, it is feasible to enhance a possibility that the loading of the data into the cache memory 4 in response to the prefetch request in each calculation core 1 catches up on the instruction execution requiring this data.

Still further, the assistant core 2 receiving the prefetch request from the cache scheduler 3 sets the busy flag in the register 7 readable from the cache scheduler 3, and clears the busy flag after the completion of prefetching. Hence, the cache scheduler 3 can easily manage the null status of the assistant core 2.

### Second Working Example

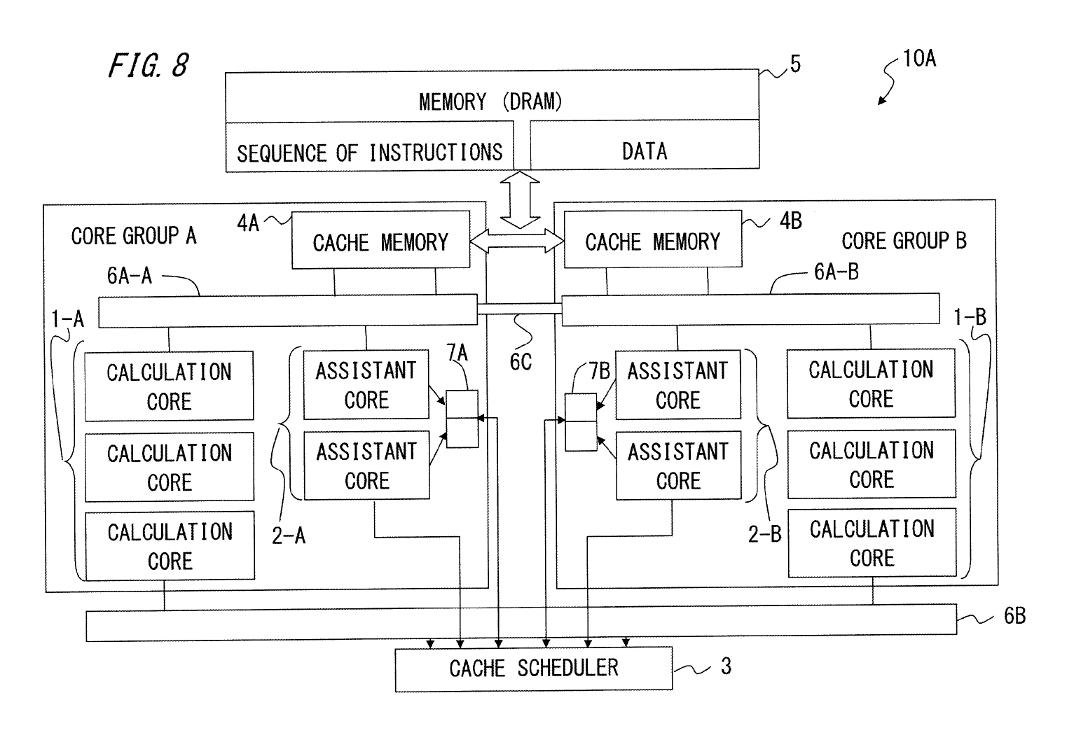

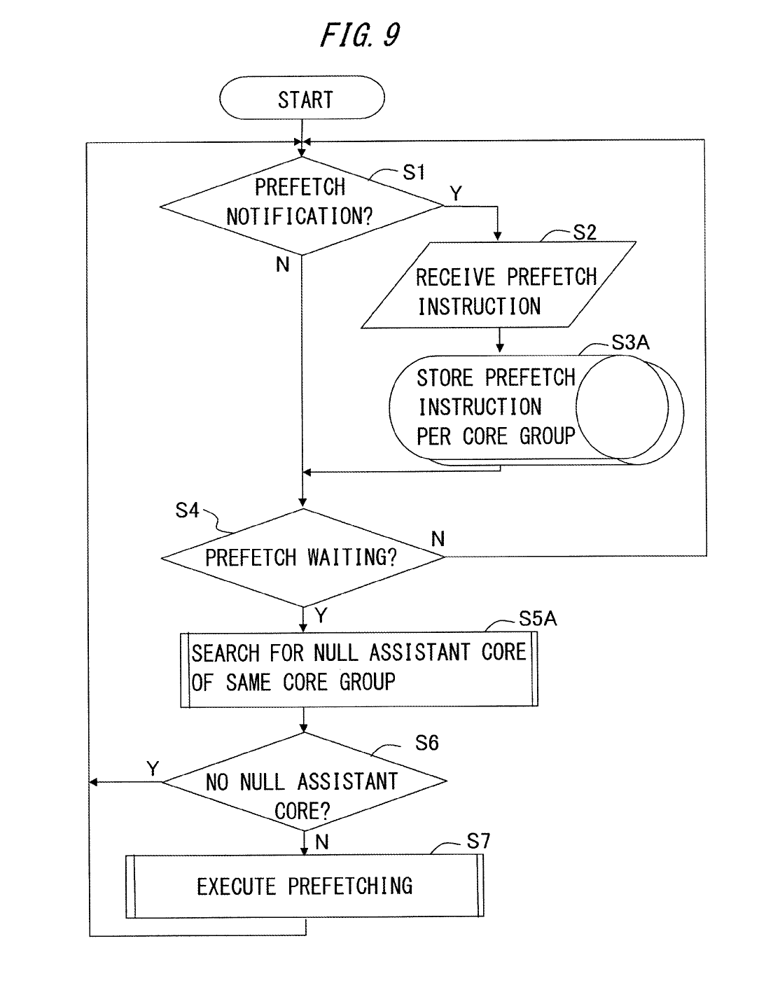

An arithmetic processing apparatus 10A according to a second working example will be described with reference to FIGS. 8 and 9. The first working example has discussed the processing instance in which the cache scheduler 3 and the plurality of assistant cores 2 cooperate to execute the prefetch instructions in parallel. The second working example will discuss a case in which the arithmetic processing apparatus 10A includes the calculation cores, and the assistant cores and the cache memories, which are separated into a plurality of core groups A, B, etc. A configuration of the arithmetic processing apparatus 10A is substantially the same as the configuration of the arithmetic processing apparatus 10 in the first working example except such a point that the cores are separated into the plurality of core groups A, B, etc. Such being the case, the same components in the second working example as the components in the first working example are marked with the same numerals and symbols, and their explanations are omitted.

FIG. 8 illustrates the configuration of the arithmetic processing apparatus according to the second working example. As in FIG. 8, the arithmetic processing apparatus 10A includes the memory 5, a core group A, a core group B and the cache scheduler 3. Further, the core group A includes a plurality of calculation cores 1-A, a plurality of assistant cores 2-A, a cache memory 4-A and a crossbar 6A-A. Still further, the core group B includes a plurality of calculation cores 1-B, a plurality of assistant cores 2-B, a cache memory 4-B and a crossbar 6A-B.

A connection between the core group A and the core group B is established via a crossbar 6C. For example, for attaining an access of the calculation core 1-A of the core group A to the cache memory 4-B, it follows that this access is done via the crossbar 6A-A in the core group A, the crossbar 6A-B in the core group B and the crossbar 6C between these core groups. Accordingly, a period of time expended for the calculation core 1-A in the core group A to access the cache memory 4-B outside the core group A is longer than a period of time expended for the calculation core 1-A in the core group A to access the cache memory 4-A in the core group A, resulting in a low accessing speed. The core group A is one example of a first group. Any one of the plurality of calculation cores 1-A in the core group A is one example of a first processing unit. Any one of the plurality of assistant cores 2-A in the core group A is one example of a second processing unit. The cache memory 4-A is one example of a first cache memory.

The same is applied to a case where the calculation core 1-B in the core group B accesses the cache memory 4-A outside the core group B. The core group B is one example of a second group. Any one of the plurality of calculation cores 1-B in the core group B is an example of another part of the first processing unit. Any one of the plurality of calculation cores 2-B in the core group B is an example of another part of the second processing unit. The cache memory 4-B is one example of a second cache memory.

In the second working example, the cache scheduler 3, when receiving the prefetch notification, performs scheduling so that the assistant core belonging to the same core group as the calculation core giving the prefetch notification belongs to executes prefetching.

FIG. 9 is a flowchart illustrating processes of the cache scheduler 3 according to the second working example. The processes in FIG. 9 are the same as the processes in FIG. 5 except the processes in S3A and S5A. In the example of FIG. 9, the cache scheduler 3, upon receiving the notified prefetch notification (S2), stores the prefetch instruction in one of the queues separated per core group of the main storage device (S3A).

Then, the cache scheduler 3, if there is the prefetch instruction in the waiting status, determines the core group from the queue of the prefetch instruction. Then, the cache scheduler 3 searches for the null assistant core 2 belonging to the same core group as the calculation core 1 notifying of the prefetch instruction in the waiting status belongs to (S5A). For example, the calculation core 1-A of the core group A notifies of the prefetch instruction, and the cache scheduler 3 searches for any one of plurality of the assistant cores 2-A of the core group A with respect to the prefetch instruction retained in the queue of the core group A. Then, the cache scheduler 3 determines which cores in the plurality of assistant cores 2-A of the core group A are in the null status (S6). Subsequently, the cache scheduler 3, if some of the plurality of assistant cores 2-A of the core group A are in the null status, selects any one of the assistant cores 2-A, taking the null status, of the core group A, and requests the selected assistant core 2 to execute the prefetch instruction (S7). What has described so far is based on the processing example in the core group A, however, the same processing is applied also to the core group B.

As discussed above, in the configuration of the second working example, with respect to the calculation cores 1, the assistant cores 2 and the cache memories 4 that are separated into the plurality of core groups, the assistant core 2 belonging to the same core group as the calculation core 1 notifying of the prefetch instruction prefetches in the cache memory 4 of the same core group. The calculation core 1 is therefore enabled to acquire the result of prefetching in the cache memory 4 of the core group to which the calculation core 1 itself belongs to. Namely, the calculation core 1 can make use of the result of prefetching from the cache memory 4 within the self-group at a higher speed than from the cache memory 4 of the different core group. What has described so far is based on exemplifying the core groups A and B, however, the same is applied also to a case in which the number of the core groups is equal to or larger than “3”.

<Non-Transitory Computer-Readable Recording Medium>

A program for making a computer, other machines and devices (which will hereinafter be referred to as the computer etc) realize any one of the functions can be recorded on a non-transitory recording medium readable by the computer etc. Then, the computer etc is made to read and execute the program on this recording medium, whereby the function thereof can be provided.

Herein, the recording medium readable by the computer etc connotes a recording medium capable of accumulating information such as data and programs electrically, magnetically, optically, mechanically or by chemical action, which can be read by the computer etc. Among these recording mediums, for example, a flexible disc, a magneto-optic disc, a CD-ROM, a CD-R/W, a DVD, a Blu-ray disc, a DAT, an 8 mm tape, a memory card such as a flash memory, etc are given as those removable from the computer. Further, a hard disc, a ROM (Read-Only Memory), etc are given as the recording mediums fixed within the computer etc.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An arithmetic processing apparatus comprising:
a plurality of first processing units to be connected to a cache memory;
a plurality of second processing units to be connected to the cache memory and to acquire, into the cache memory, data to be processed by the first processing unit before each of the plurality of first processing units executes processing; and
a schedule processing unit to control a schedule for acquiring the data of the plurality of second processing units into the cache memory.

2. The arithmetic processing apparatus according to claim 1, wherein the first processing unit requests the schedule processing unit to acquire the data to be processed, and
the schedule processing unit instructs the second processing unit not executing the acquisition of the requested data into the cache memory underway to acquire the requested data.

3. The arithmetic processing apparatus according to claim 1, wherein the cache memory includes a first cache memory and a second cache memory,
a part of the plurality of first processing units, a part of the plurality of second processing units and the first cache memory belong to a first group, while another part of the plurality of first processing units, another part of the plurality of second processing units and the second cache memory belong to a second group, and
the schedule processing unit instructs the second processing units belonging to the respective groups to acquire the requested data with respect to data acquiring requests given from the first processing units belonging to the respective groups.

4. An information processing apparatus comprising:
main memory;
a cache memory to retain data of the main memory;
a plurality of first processing units to share the cache memory with each other;
a plurality of second processing units to share the cache memory with the plurality of first processing units and to acquire, into the cache memory, the data to be processed by the first processing units before each of the plurality of first processing units executes processing; and
a schedule processing unit to control a schedule for acquiring the data of the plurality of second processing units into the cache memory.

5. The information processing apparatus according to claim 4, wherein the first processing unit requests the schedule processing unit to acquire the data to be processed, and
the schedule processing unit instructs the second processing unit not executing the acquisition of the data into the cache memory underway to acquire the requested data.

6. The information processing apparatus according to claim 4, wherein the cache memory includes a first cache memory and a second cache memory,
a part of the plurality of first processing units, a part of the plurality of second processing units and the first cache memory belong to a first group, while another part of the plurality of first processing units, another part of the plurality of second processing units and the second cache memory belong to a second group, and
the schedule processing unit instructs the second processing units belonging to the respective groups to acquire the requested data with respect to data acquiring requests given from the first processing units belonging to the respective groups.

7. A control method of an arithmetic processing apparatus including a cache memory, comprising:
requesting by a first processing unit of the arithmetic processing apparatus a schedule processing unit to acquire data to be processed into the cache memory; and
instructing by the schedule processing unit a second processing unit not executing acquisition of the data into the cache memory to acquire the requested data.

8. The control method of the arithmetic processing apparatus according to claim 7, the cache memory including a first cache memory and a second cache memory,
a part of a plurality of first processing units, a part of a plurality of second processing units and the first cache memory belonging to a first group, and another part of the plurality of first processing units, another part of the plurality of second processing units and the second cache memory belonging to a second group,
wherein the instructing by the schedule processing unit includes instructing any one of the plurality of second processing units belonging to the respective groups to acquire the requested data with respect to data acquiring requests given from any one of the plurality of first processing units belonging to the respective groups.
